(19) United States
(12) Patent Application Publication
(10) Pub. No.: US 2015/0273591 A1
(43) Pub. Date: Oct. 1, 2015

(54) BORING TOOL

(71) Applicant: MITSUBISHI HEAVY INDUSTRIES, LTD., Tokyo (JP)

(72) Inventor: Kazuto NAKAMURA, Tokyo (JP)

(73) Assignee: MITSUBISHI HEAVY INDUSTRIES, LTD., Tokyo (JP)

(21) Appl. No.: 14/666,818

(22) Filed: Mar. 24, 2015

(30) Foreign Application Priority Data
Mar. 27, 2014 (JP) 2014-065219

(51) Int. Cl. B23B 29/034

(52) U.S. Cl. CPC B23B 29/034; B23B 2229/00; B23B 2260/034

(57) ABSTRACT

A boring tool includes: a cutter provided on an outer peripheral portion of a tool main body; a draw bar supported to be slidable in a tool axial direction in a center hole of the tool main body; cutting edge position adjusting means for adjusting a cutting edge position of the cutter in a tool radial direction depending on a position of the draw bar in the tool axial direction; and a spring for biasing and positioning the draw bar in the tool axial direction in mounting of the tool main body on a main spindle of a machine tool.

### TECHNICAL FIELD

The present invention relates to a boring tool in which a cutting edge position is adjustable in a tool radial direction.

### BACKGROUND ART

Various types of boring tools in which the cutting edge position is adjustable in the tool radial direction have been conventionally provided.

Generally, in each of such boring tools, a tool-side draw bar is slidably supported in a tool main body. When the boring tool is mounted on a main spindle of a machine tool, the tool-side draw bar is connected to a main spindle-side draw bar. When the main spindle-side draw bar is made to slide with the draw bars being connected to each other, the tool-side draw bar also slides and the position of a cutting edge in the tool radial direction is adjusted depending on the position of the tool-side draw bar in a tool axial direction.

Since a tool diameter (machining diameter) can be changed by adjusting the cutting edge position in the boring tool in the tool radial direction as described above, even a machining surface with a complex shape can be easily machined.

A conventional boring tool like one described above is disclosed in, for example, Patent Literature 1.

### CITATION LIST

### Patent Literature

{Patent Literature 1} Japanese Patent Application Publication No. 2003-260608

### SUMMARY OF INVENTION

### Technical Problem

Moreover, among machine tools, there is provided a machine tool with an automatic tool replacement function. In a case of using the aforementioned boring tool in the machine tool having such an automatic tool replacement function, the tool-side drawbar needs to be positioned in the tool axial direction in the mounting of the boring tool on the main spindle.

Specifically, in the mounting of the boring tool on the main spindle, the tool-side draw bar and the main spindle-side draw bar cannot be appropriately connected to each other unless the tool-side draw bar is positioned in the tool axial direction. As a result, there is a risk that the boring tool cannot be automatically replaced.

The present invention has been made to solve the problems described above, and an object thereof is to provide a boring tool which enables appropriate automatic tool replacement.

### Solution to Problem

A first aspect of the present invention for solving the problems described above provides a boring tool including:
a cutter provided on an outer peripheral portion of a tool main body;
a draw bar supported to be slidable in a tool axial direction in a center hole of the tool main body;
cutting edge position adjusting means for adjusting a cutting edge position of the cutter in a tool radial direction depending on a position of the draw bar in the tool axial direction; and
positioning means for positioning the draw bar in the tool axial direction in mounting of the tool main body on a main spindle of a machine tool.

A second aspect of the present invention for solving the problems described above provides the boring tool wherein the positioning means is biasing means, interposed between the center hole and the draw bar, for biasing the draw bar in the tool axial direction.

A third aspect of the present invention for solving the problems described above provides the boring tool wherein the positioning means includes:
an engagement member supported to be capable of advancing to and retreating from the center hole; and
a recess portion formed on an outer peripheral surface of the draw bar and configured to engage with the engagement member.

A fourth aspect of the present invention for solving the problems described above provides the boring tool wherein the cutting edge position adjusting means includes:
a cutter supporting member to which the cutter is attached and which elastically deforms outward in the tool radial direction from the outer peripheral portion of the tool main body;
an inclined surface which is formed on the draw bar and which is inclined inward in the tool radial direction; and
a pushing pin which is supported to be slidable in the tool radial direction in the tool main body and which pushes the cutter supporting member outward in the tool radial direction by sliding on the inclined surface.

A fifth aspect of the present invention for solving the problems described above provides the boring tool wherein the draw bar is configured such that a front end side shaft portion including the inclined surface is separable.

A sixth aspect of the present invention for solving the problems described above provides the boring tool wherein the cutting edge position adjusting means includes:
a guide plate which slides in the tool axial direction together with the draw bar;
a guide groove which is formed in the guide plate and which is inclined with respect to the tool axial direction;
a cutter supporting member to which the cutter is attached and which is supported on the tool main body to be slidable in the tool radial direction; and
a slide pin which has one end slidably supported in the guide groove and another end fixed to the cutter supporting member.

A seventh aspect of the present invention for solving the problems described above provides the boring tool wherein the guide plate is detachably attached to the draw bar.

An eighth aspect of the present invention for solving the problems described above provides the boring tool wherein a plurality of the cutting edge position adjusting means are provided in the tool axial direction.

### Advantageous Effects of Invention

The boring tool of the present invention includes the positioning means for positioning the draw bar in the tool axial direction in the mounting of the tool main body to the main spindle of the machine tool. Accordingly, automatic tool replacement can be appropriately performed.

### BRIEF DESCRIPTION OF DRAWINGS

FIG. 1 is a vertical cross-sectional view in a case where a boring tool of Embodiment 1 of the present invention is mounted on a main spindle.

FIG. 2 is a vertical cross-sectional view in a case where a draw bar in the boring tool of Embodiment 1 of the present invention has a divided structure.

FIG. 3 is a vertical cross-sectional view in a case where a boring tool of Embodiment 2 of the present invention is mounted on a main spindle.

FIG. 4A is a vertical cross-sectional view in a case where a boring tool of Embodiment 3 of the present invention is mounted on a main spindle, and shows a maximum tool diameter state.

FIG. 4B is a cross-sectional view taken along the line IV-IV and viewed in the direction of the arrows in FIG. 4A.

FIG. 5A is a vertical cross-sectional view in a case where the boring tool of Embodiment 3 of the present invention is mounted on the main spindle, and shows a minimum tool diameter state.

FIG. 5B is a cross-sectional view taken along the line V-V and viewed in the direction of the arrows in FIG. 5A.

FIG. 6A is a cross-sectional view in a case where the boring tool of Embodiment 3 of the present invention includes multiple cutters in the tool axial direction.

FIG. 6B is a cross-sectional view taken along the line VI-VI and viewed in the direction of the arrows in FIG. 6A.

FIG. 6C is a vertical cross-sectional view of a hole with grooves subjected to boring using the boring tool shown in FIG. 6A.

FIG. 7A is a vertical cross-sectional view in a case where a boring tool of Embodiment 4 of the present invention is mounted on the main spindle, and shows a maximum tool diameter state.

FIG. 7B is a vertical cross-sectional view of a stepped shaft subjected to boring using the boring tool shown in FIG. 7A.

### DESCRIPTION OF EMBODIMENTS

A boring tool of the present invention is described below in detail by using the drawings.

### Embodiments

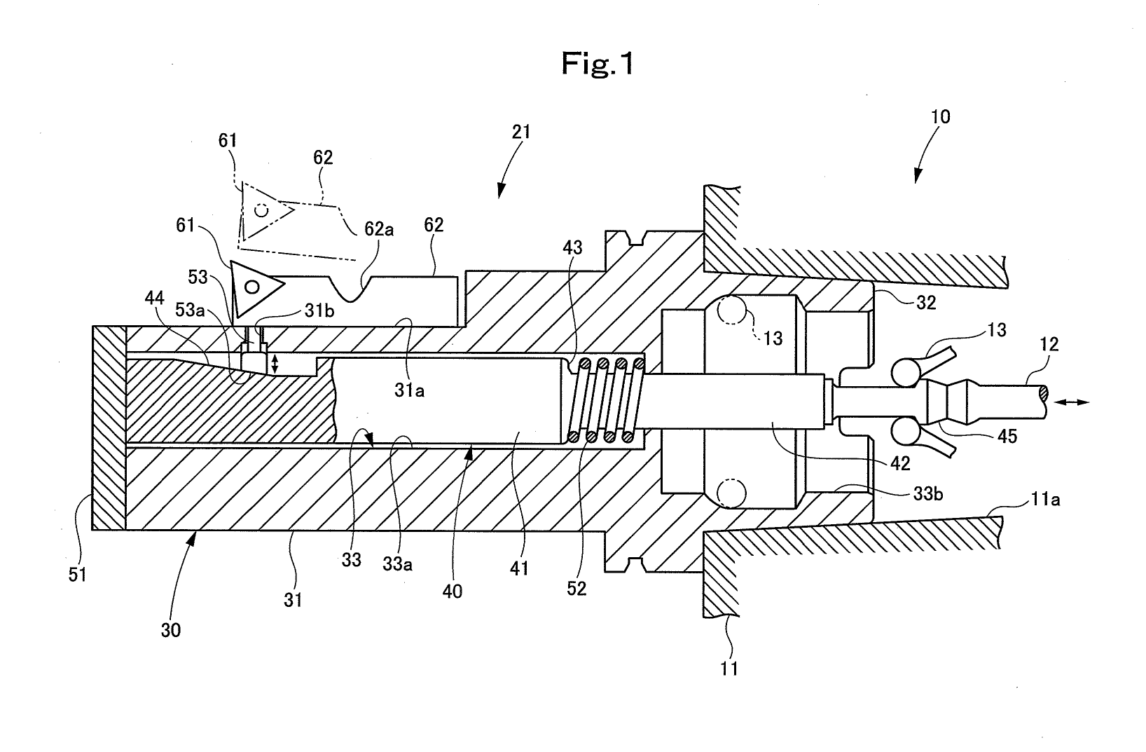

First, a machine tool 10 shown in FIGS. 1, 3, 4A, 4B, 5A, 5B, and 7 has an automatic tool replacement function which enables automatic replacement of a tool on a main spindle 11. The tool which is a replacement target is a tool with a so-called U-axis function in which a cutting edge position is adjustable in a tool radial direction or a normal tool which has no U-axis function.

Boring tools 21 to 24 which are tools with the aforementioned U-axis function are described below as Embodiments 1 to 4. Note that, in Embodiments 1 to 4, members having the same configuration and the same function are denoted by the same reference numeral.

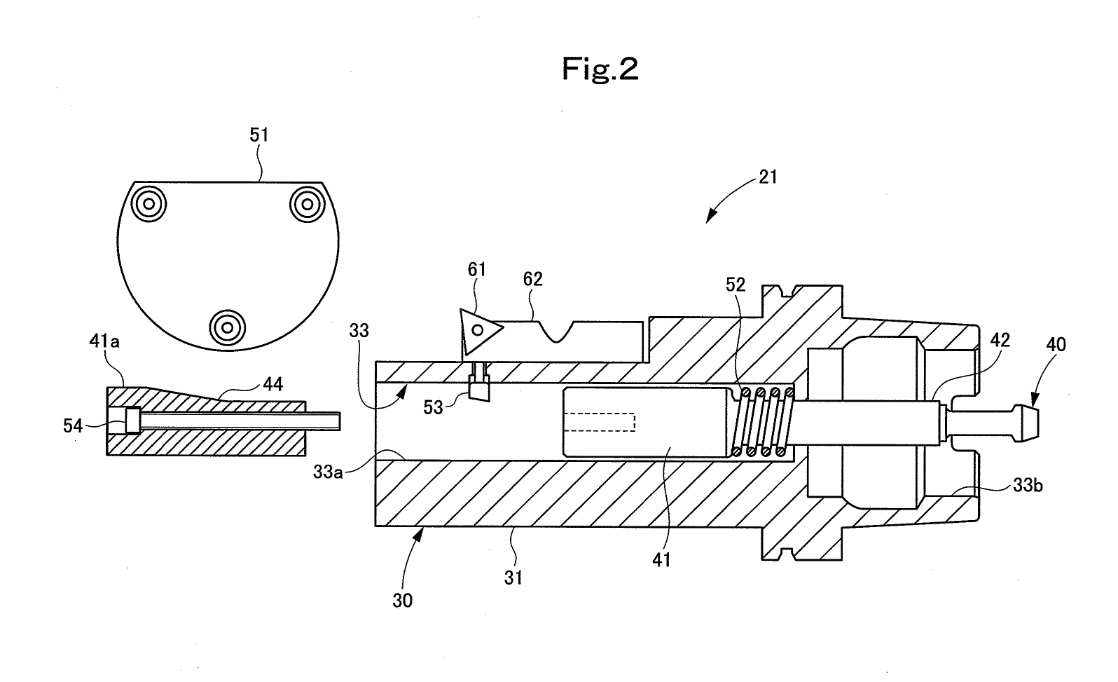

First, Embodiment 1 is described in detail by using FIGS. 1 and 2.

As shown in FIG. 1, the boring tool 21 is provided with a tubular tool main body 30, and the tool main body 30 includes a shaft portion 31 located on a tool front end side, a shank portion 32 located on a tool base end side, and a center hole 33 penetrating a center portion of the tool main body 30.

A cutter supporting surface 31a is formed in an outer peripheral portion of the shaft portion 31 on the tool front end side to be recessed inward in the tool radial direction. In other words, the cutter supporting surface 31a is a surface orthogonal to the tool radial direction (U-axis direction). Furthermore, a base end of a cutter supporting member (elastic body) 62 is supported on the cutter supporting surface 31a, and a cutter (cutting tip) 61 is detachably attached to a front end of the cutter supporting member 62.

A notch portion 62a is formed in an intermediate portion of the cutter supporting member 62. This allows the front end of the cutter supporting member 62 to elastically deform outward in the tool radial direction about the based end thereof.

Specifically, when the cutter supporting member 62 elastically deforms outward in the tool radial direction, the cutting edge position of the cutter 61 also moves outward in the tool radial direction. Accordingly, the tool diameter of the boring tool 21 expands. Moreover, when the cutter supporting member 62 returns inward in the tool radial direction to its original shape, the cutting edge position of the cutter 61 also moves inward in the tool radial direction. Accordingly the tool diameter of the boring tool 21 thereby contracts.

Note that the cutter 61 illustrated by solid lines in FIG. 1 is in a minimum tool diameter state where the cutter supporting member 62 is not elastically deformed and the cutting edge position is at the innermost position in the tool radial direction. Meanwhile, the cutter 61 illustrated by double-dot-dash lines in FIG. 1 is in a maximum tool diameter state where the cutter supporting member 62 is elastically deformed and the cutter position is at the outermost position in the tool radial direction.

The shank portion 32 has a tapered shape whose outer diameter gradually becomes smaller from the tool front end side toward the tool base end side, and can be fitted into a center hole 11a of the main spindle 11.

The center hole 33 is formed to be coaxial with the shaft portion 31 and the shank portion 32, and includes a tool front end side center hole 33a located in the shaft portion 31 and a tool base end side center hole 33b located in the shank portion 32. A lid member 51 is attached to an end surface of the shaft portion 31 on the tool front end side to close the center hole 33 (tool front end side center hole 33a).

Meanwhile, in the center hole 33 of the tool main body 30, a draw bar 40 is supported to be slidable in tool axial direction. The draw bar 40 includes a large-diameter shaft portion 41 which is located on the tool front end side, a small-diameter shaft portion 42 which is located on the tool base end side, a step portion 43 which is a connection portion between the large-diameter shaft portion 41 and the small-diameter shaft portion 42, an inclined surface 44 which is formed in the large-diameter shaft portion 41, and a pull stud 45 which is provided in an end portion of the small-diameter shaft portion 42 on the tool base end side.

A spring (positioning means, biasing means) 52 is provided outside, in the radial direction, the small-diameter shaft portion 42 disposed in the tool front end side center hole 33a. The spring 52 is interposed between an inner end surface of the tool front end side center hole 33a on the tool base end side and the step portion 43 of the draw bar 40 to bias the draw bar 40 toward the front end side in the tool axial direction. As will be described in detail later, this can set the draw bar 40 in a state positioned in the tool axial direction when the boring tool 21 is dismounted from the main spindle 11, because the large-diameter shaft portion 41 is pushed by biasing force of the spring 52 but the movement of the draw bar 40 toward the tool front end side is restricted by the lid member 51.

Moreover, the inclined surface 44 faces the cutter supporting member 62 in the tool radial direction and is formed to be gradually inclined inward in the tool radial direction from the tool front end side toward the tool base end side. Furthermore, a supporting hole 31b is formed in the shaft portion 31 to extend in the tool radial direction. The supporting hole 31b is opened on the cutter supporting surface 31a and communicates with the tool front end side center hole. 33a.

A pushing pin 53 is supported by the supporting hole 31b to be capable of advancing from and retreating to the cutter supporting surface 31a. The pushing pin 53 includes an inclined surface 53a at its base end portion. The inclined surface 53a is formed to be gradually inclined inward in the tool radial direction from the tool front end side toward the tool base end side, and is capable of sliding on the inclined surface 44 in an inclination direction thereof. Note that the inclined surface 44, the pushing pin 53, the inclined surface 53a, and the cutter supporting member 62 form cutting edge position adjusting means.

Meanwhile, the main spindle 11 is rotatably supported by the machine tool 10. In the center hole 11a of the main spindle 11, a draw bar 12 is supported to be slidable in a main spindle axial direction and to be rotatable together with the main spindle 11. Furthermore, a collet 13 is supported on a main spindle front end side of the draw bar 12 to be openable and closeable in a main spindle radial direction. The collet 13 can clamp the pull stud 45 of the draw bar 40 by closing inward in the main spindle radial direction and unclamp the pull stud 45 of the draw bar 40 by opening outward in the main spindle radial direction.

Next, description is given of an automatic tool replacement operation (mounting-dismounting operation) of the boring tool 21 and a tool diameter expanding-contracting operation in the boring tool 21.

First, as shown in FIG. 1, the boring tool 21 is moved toward the main spindle 11 by using the automatic tool replacement function. At this time, in the boring tool 21, the draw bar 40 is positioned in the tool axial direction by the biasing force of the spring 52.

Next, when the boring tool 21 is mounted on the main spindle 11, the draw bar 12 retreats toward the main spindle base end side. This causes the collet 13 to close while retreating toward the main spindle based end side and clamp the pull stud 45 (position illustrated by solid lines in FIG. 1).

In this case, since the draw bar 40 is positioned in the tool axial direction as described above, the position of the pull stud 45 in the tool axial direction is always the same in the main spindle mounting of the boring tool 21. Since the collet 13 can thus surely clamp the pull stud 45, the draw bar 40 of the boring tool 21 and the draw bar 12 of the main spindle 11 are appropriately connected to each other.

Then, rotating the main spindle 11 causes the boring tool 21 to rotate together with the main spindle 11, and the cutter 61 rotates with this rotation about a tool center axis (main spindle center axis) to perform boring.

When the draw bar 12 is made to slide in the main spindle direction with the draw bars 12 and 40 being connected to each other as described above, the draw bar 40 also slides in the tool axial direction with the sliding of the draw bar 12, and the cutting edge position of the cutter 61 is adjusted in the tool radial direction. The tool diameter expanding-contracting operation like one described above can be performed both during machining and before machining.

Specifically, when the draw bar 12 is advanced toward the main spindle front end side, the draw bar 40 is also simultaneously advanced toward the tool front end side while being biased by the spring 52. This causes the pushing pin 53 to move inward in the tool radial direction due to sliding of the inclined surfaces 44 and 53a. As a result, the cutter supporting member 62 elastically deforms by an amount corresponding to a protruding amount of the pushing pin 53 from the cutter supporting surface 31a, and the cutting edge position of the cutter 61 moves inward in the tool radial direction. In other words, the tool diameter (cutting edge diameter) of the boring tool 21 can be minimized.

Meanwhile, when the draw bar 12 is retreated toward the main spindle base end side, the draw bar 40 is also simultaneously retreated toward the tool base end side against the biasing force of the spring 52. This causes the pushing pin 53 to move outward in the tool radial direction due to sliding of the inclined surfaces 44 and 53a. As a result, the cutter supporting member 62 elastically deforms by an amount corresponding to the protruding amount of the pushing pin 53 from the cutter supporting surface 31a, and the cutting edge position of the cutter 61 moves outward in the tool radial direction. In other words, the tool diameter (cutting edge diameter) of the boring tool 21 can be maximized.

Next, when the boring is completed, the draw bar 12 is advanced toward the main spindle front end side. This causes the collet 13 to open while advancing toward the main spindle front end side and unclamp the pull stud 45 (position shown by double-dot-dash lines in FIG. 1). At the same time, the draw bar 40 receives only the biasing force of the spring 52, and the draw bar 40 is set to a state positioned in the tool axial direction.

Then, the boring tool 21 is dismounted from the main spindle 11 by further advancing the draw bar 12 toward the main spindle front end side. The dismounted boring tool 21 is moved away by using the automatic tool replacement function.

As described above, in the boring tool 21 of the present invention, the draw bar 40 can be positioned in the tool axial direction by the biasing force of the spring 52 in the mounting on the main spindle 11. Since this enables secure connection between the drawbars 12 and 40, it is possible to automatically and appropriately replace the boring tool 21 in which the cutting edge position of the cutter 61 is adjustable in the tool radial direction.

Note that, as shown in FIG. 2, the draw bar 40 may be designed such that a tool front end side shaft portion 41a of the large-diameter shaft portion 41 which includes the inclined surface 44 can be attached and detached by using a bolt 54. The draw bar 40 has a risk that the inclined surface 44 wares due to sliding on the inclined surface 53a of the pushing pin 53. However, designing the draw bar 40 to have a separating structure separated at the inclined surface 44 as described above can improve the maintainability.

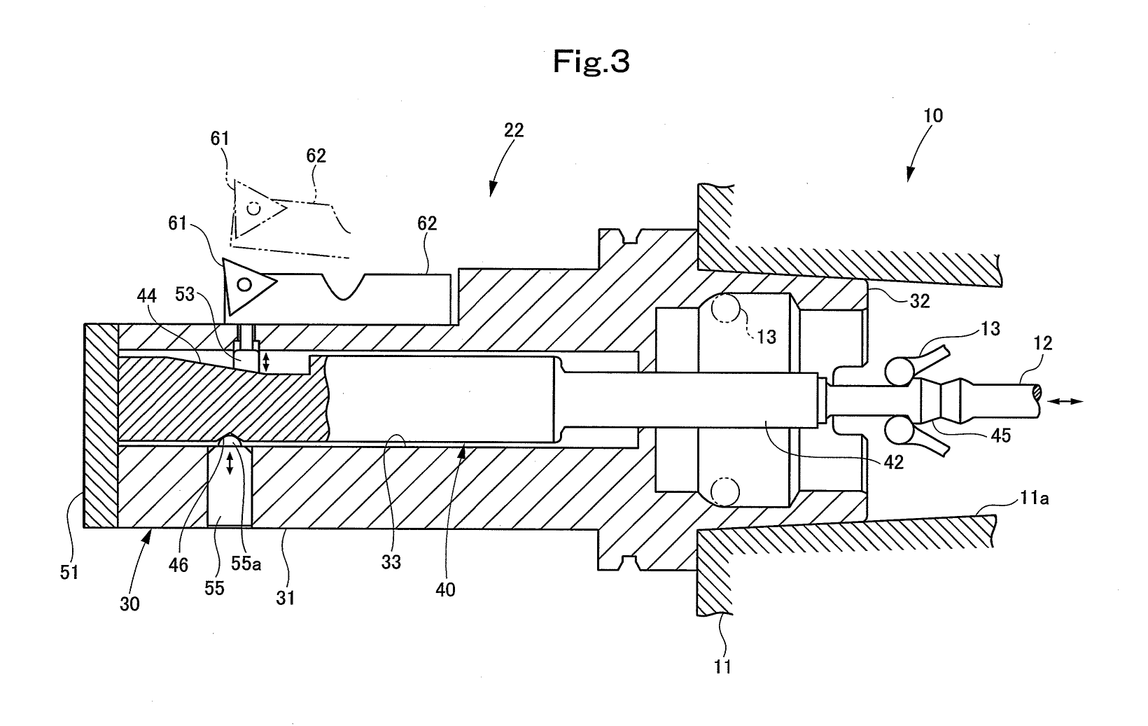

Next, Embodiment 2 is described in detail by using FIG. 3.

As shown in FIG. 3, in a boring tool 22, a notch 46 and a holder 55 are used as positioning means. The holder 55 is embedded in a shaft portion 31, and an engagement ball (engagement member) 55a is supported by a front end of the holder 55 to be capable of advancing to and retreating from a center hole 33. Meanwhile, the notch (recess portion) 46 is formed on an outer peripheral surface of a draw bar 40 and can engage with the engagement ball 55a. Specifically, when the boring tool 22 is dismounted from the main spindle 11, the notch 46 is engaged with the engagement ball 55a and the draw bar 40 is in a state positioned in a tool axial direction.

Accordingly, in the boring tool 22 of the present invention, the draw bar 40 can be positioned in the tool axial direction by the engagement between the notch 46 and the engagement ball 55a in mounting on a main spindle 11. Since this enables secure connection between the draw bars 12 and 40, it is possible to automatically and appropriately replace the boring tool 22 in which a cutting edge position of a cutter 61 is adjustable in a tool radial direction.

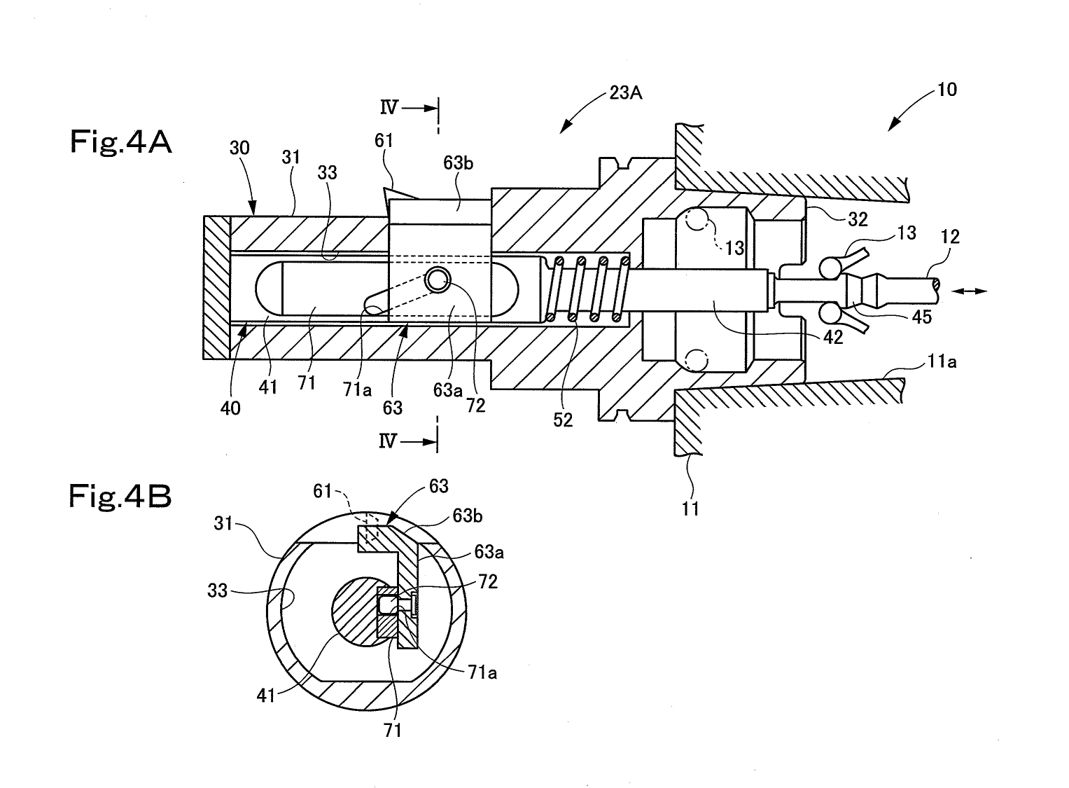

Next, Embodiment 3 is described in detail by using FIGS. 4A, 4B, 5A, 5B, and 6.

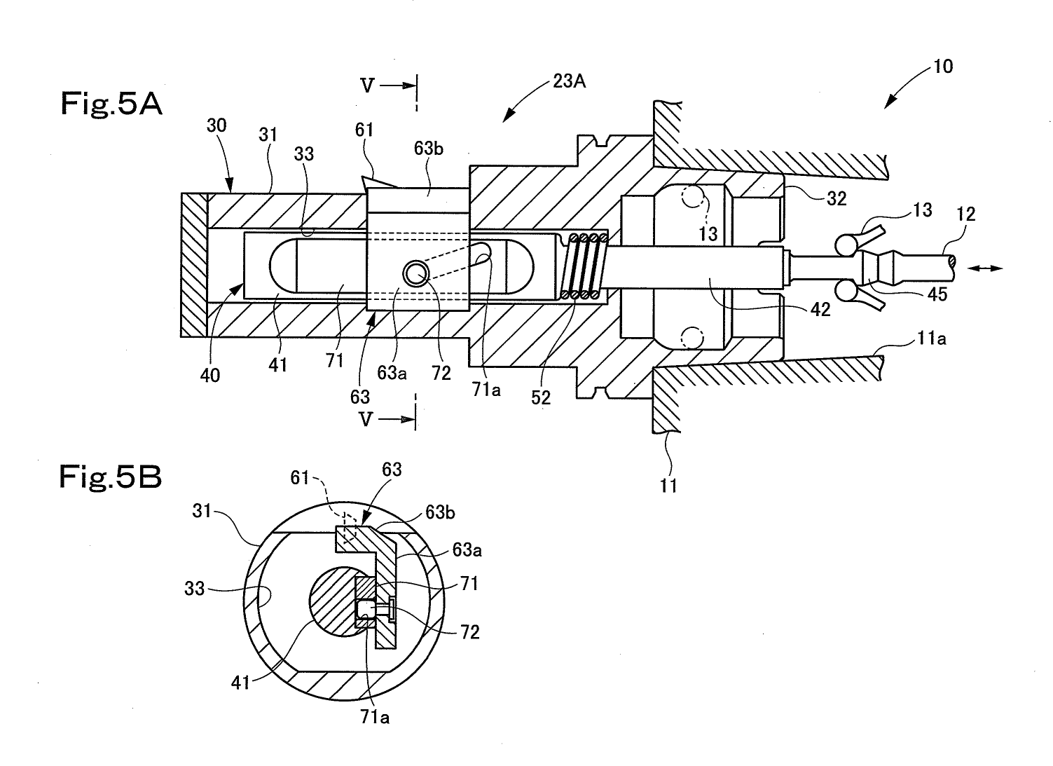

As shown in FIGS. 4A, 4B, 5A, and 5B, in a boring tool 23A, the spring 52 is employed as positioning means, and a cutter supporting member 63, a guide plate 71, and a slide pin 72 are used as cutting edge position adjusting means.

Specifically, the guide plate 71 is detachably attached to a draw bar 40. A guide groove 71a is formed in the guide plate 71 and is inclined to intersect the tool axial direction. Moreover, in the guide groove 71a, the slide pin 72 is supported to be slidable in an inclination direction of the guide groove 71a.

Meanwhile, the cutter supporting member 63 is supported by the shaft portion 31 of the tool main body 30 to be slidable in a tool radial direction. The cutter supporting member 63 includes a slide portion 63a and a cutter supporting portion 63b.

The slide portion 63a is formed in a plate shape. The slide portion 63a is supported to be slidable in the tool radial direction in the shaft portion 31 and faces the guide groove 71a of the guide plate 71. A base end of the slide pin 72 is fixed to a center portion of the slide portion 63a. Moreover, the cutter supporting portion 63b is formed at one end of the slide portion 63a and extends orthogonally to the slide portion 63a. A cutter 61 is detachably attached a front end side of the cutter supporting portion 63b in the tool axial direction.

Accordingly, when the draw bar 40 is made to slide in the tool axial direction, the guide groove 71a of the guide plate 71 also slides in the tool axial direction with the sliding of the draw bar 40. This causes the position of the slide pin 72 in the tool radial direction to change depending on the position of the guide groove 71a in the tool axial direction, and the cutter supporting member 63 thereby slides in the tool radial direction. As a result, the cutting edge position of the cutter 61 is adjusted in the tool radial direction.

Specifically, as shown in FIGS. 4A and 4B, when a draw bar 12 is advanced toward a main spindle front end side, the draw bar 40 is also simultaneously advanced toward the tool front end side while being biased by a spring 52. This causes the cutter supporting member 63 to move outward in the tool radial direction due to the guiding of the slide pin 72 by the guide groove 71a, and the cutting edge position of the cutter 61 thereby moves outward in the tool radial direction. In other words, the tool diameter (cutting edge diameter) of the boring tool 23A can be maximized.

Meanwhile, as shown in FIGS. 5A and 5B, when the draw bar 12 is retreated toward a main spindle base end side, the drawbar 40 is also simultaneously retreated toward a tool base end side against the biasing force of the spring 52. This causes the cutter supporting member 63 to move inward in the tool radial direction due to the guiding of the slide pin 72 by the guide groove 71a, and the cutting edge position of the cutter 61 thereby moves inward in the tool radial direction. In other words, the tool diameter (cutting edge diameter) of the boring tool 23A can be minimized.

Accordingly, it is possible to automatically and appropriately replace the boring tool 23A in which the cutting edge position of the cutter 61 is adjustable in the tool radial direction. Moreover, even when the guiding groove 71a wears due to sliding of the slide pin 72, the guide plate 71 can be easily replaced because the guide plate 71 is detachably attached to the draw bar 40, and the maintainability can be improved. Furthermore, a tool diameter expansion-contraction pattern can be easily changed by adjusting the length and inclination angle of the guide groove 71a.

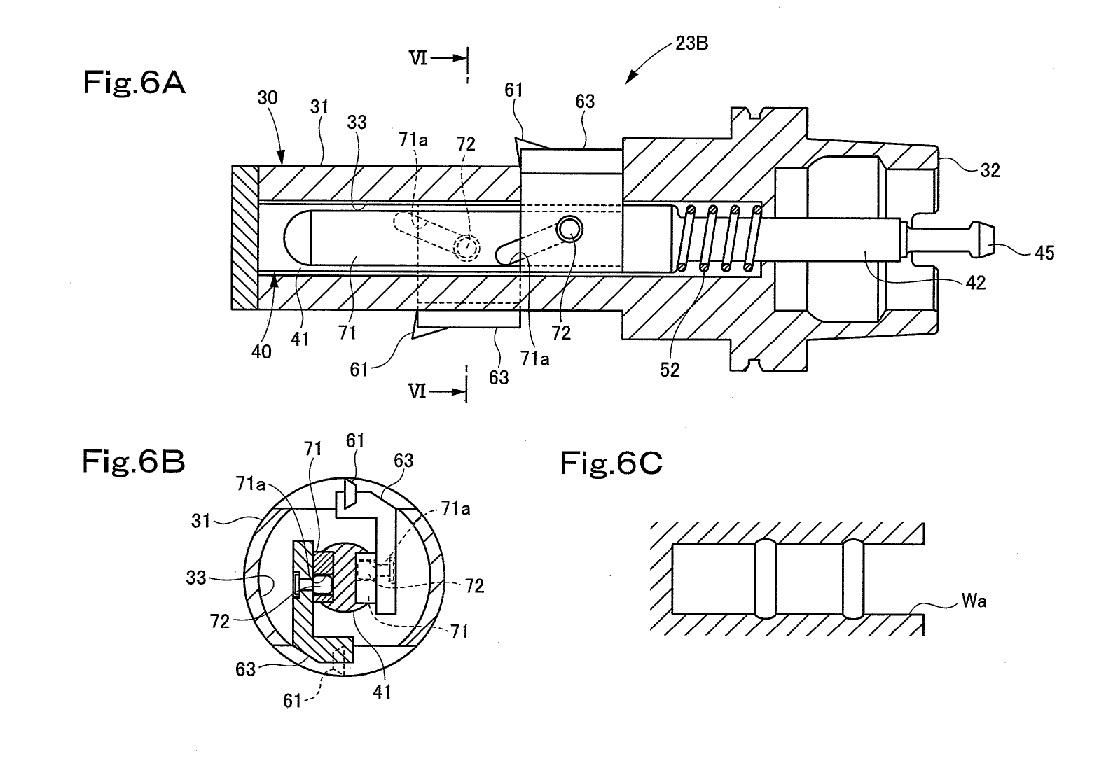

Here, as shown in a boring tool 23B illustrated in FIGS. 6A and 6B, multiple cutting edge position adjusting means each formed of the cutter supporting member 63, the guide plate 71, and the slide pin 72 can be provided in the tool axial direction. In the boring tool 23B, the cutting edge position adjusting means are arranged to be symmetric about a tool center axis (draw bar 40).

Due to this configuration, in the guide plates 71 arranged point symmetric to each other, the inclination directions of the respective guide grooves 71a in the tool radial direction are opposite to each other. Accordingly, when the draw bar 40 is made to slide in the tool axial direction, the cutting edge position of one cutter 61 and the cutting edge position of the other cutter 61 move in opposite directions in the tool radial direction. In other words, it is possible to set the cutting edge position of the one cutter 61 and the cutting edge position of the other cutter 61 not only at the same position but also at different positions in the tool radial direction.

Accordingly, as shown in FIG. 6C, a hole Wa with grooves can be easily machined in one pass (one boring process) by using the boring tool 23B.

Note that, although the spring 52 is used as the positioning means in the aforementioned boring tools 23A and 23B, the notch 46 and the holder 55 may be used as the positioning means.

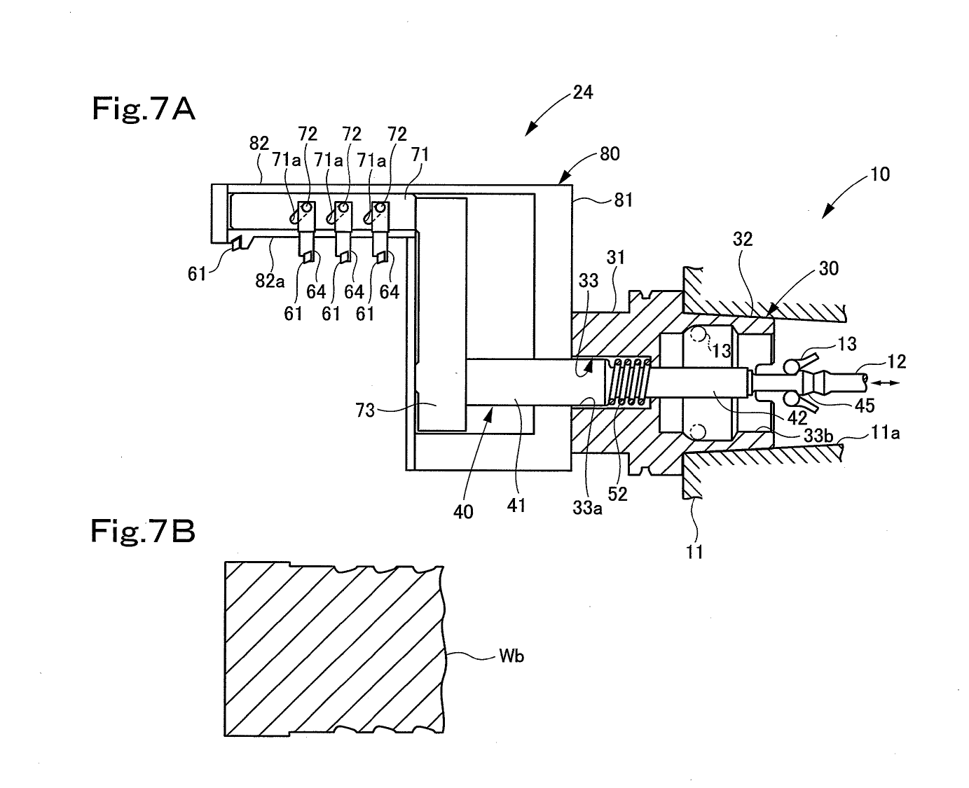

Next, Embodiment 4 is described in detail by using FIGS. 7A and 7B.

As shown in FIG. 7A, a frame-shaped member 80 is provided on a tool front end side of a boring tool 24. The frame-shape member 80 includes a large frame portion 81 located on a tool base end side and a small frame portion 82 located on the tool front end side.

The large frame portion 81 is supported on an end surface of a shaft portion 31 on the tool front end side, and a large-diameter shaft portion 41 of a draw bar 40 is supported in the large frame portion 81 to be slidable in a tool axial direction. An inner end portion of an extending member 73 in a tool radial direction is supported by a front end of the large-diameter shaft portion 41, and the guide plate 71 is supported by an outer end portion of the extending member 73 in the tool radial direction. In other words, the extending member 73 is arranged to extend outward in the tool radial direction from the large-diameter shaft portion 41.

Moreover, the small frame portion 82 communicates with an outer portion of the large frame portion 81 in the tool radial direction, and the guide plate 71 is supported in the small frame portion 82 to be slidable in the tool axial direction. Multiple guide grooves 71a are formed at even intervals in the tool axial direction in the guide plate 71 housed in the small frame portion 82. The guide grooves 71a are all inclined in the same direction at the same angle, and slide pins 72 are slidably supported in the guide grooves 71a.

Furthermore, an inner frame plate 82a is arranged on an inner side of the small frame portion 82 in the tool radial direction, and one cutter 61 which are fixed blades and three cutter supporting members 64 are provided in the inner frame plate 82a in a manner arranged from the tool front end side toward the tool base end side.

The cutter supporting members 64 are supported to be slidable in the tool radial direction with respect to the inner frame plate 82a and face the guide grooves 71a of the guide plate 71, respectively. Base ends of the slide pins 72 are supported respectively by outer end portions of the cutter supporting members 64 in the tool radial direction, and the cutters 61 are detachably attached respectively to inner end portions of the cutter supporting members 64 in the tool radial direction. Note that cutter supporting members 64, the guide plate 71, and the slide pins 72 form the cutting edge position adjusting means.

Due to the configuration described above, although the extending member 73 is pushed by biasing force of a spring 52 when the boring tool 21 is dismounted from the main spindle 11, since movement of the draw bar 40 toward the tool front end side is restricted by an inner surface of the large frame portion 81, the draw bar 40 is set in a state positioned in the tool axial direction.

Accordingly, when the drawbar 40 is made to slide in the tool axial direction, the guide grooves 71a of the guide plate 71 also slide in the tool axial direction together with the sliding of the draw bar 40. This causes the positions of the slide pins 72 in the tool radial direction to change depending on the positions of the guide grooves 71a in the tool axial direction, and the cutter supporting members 64 thereby slides in the tool radial direction. As a result, the cutting edge positions of the cutters 61 are adjusted in the tool radial direction.

Specifically, when a draw bar 12 is advanced toward a main spindle front end side, the draw bar 40 is also simultaneously advanced toward the tool front end side while being biased by the spring 52. This causes the cutter supporting members 64 to move outward in the tool radial direction due to the guiding of the slide pins 72 by the guide grooves 71a, and the cutting edge positions of the cutters 61 move outward in the tool radial direction. In other words, the tool diameter (cutting edge diameter) of the boring tool 24 can be maximized.

Meanwhile, when the draw bar 12 is retreated toward a main spindle base end side, the draw bar 40 is also simultaneously retreated toward the tool base end side against the biasing force of the spring 52. This causes the cutter supporting members 64 to move inward in the tool radial direction due to the guiding of the slide pins 72 by the guide grooves 71a, and the cutting edge positions of the cutters 61 move inward in the tool radial direction. In other words, the tool diameter (cutting edge diameter) of the boring tool 24 can be minimized.

Accordingly, as shown in FIG. 7A, the cutting edge positions of the multiple cutters 61 can be set at the same position in the tool radial direction. Use of the boring tool 24 thereby enables easy machining of a stepped shaft Wb in one pass (one boring process) as shown in FIG. 7B.

### INDUSTRIAL APPLICABILITY

The present invention can be applied to a boring tool designed to increase the speed of automatic tool replacement.

### REFERENCE SIGNS LIST

10 Machine Tool
11 Main Spindle
12 Draw Bar
21 To 24 Boring Tool
30 Tool Main Body
40 Draw Bar
44 Inclined Surface
46 Notch
52 Spring
53 Pushing Pin
55 Holder
55a Engagement Ball
61 Cutter
62 To 64 Cutter Supporting Member
71 Guide Plate
71a Guide Groove
72 Slide Pin

1. A boring tool comprising:
a cutter provided on an outer peripheral portion of a tool main body;
a draw bar supported to be slidable in a tool axial direction in a center hole of the tool main body;
cutting edge position adjusting means for adjusting a cutting edge position of the cutter in a tool radial direction depending on a position of the draw bar in the tool axial direction; and
positioning means for positioning the draw bar in the tool axial direction in mounting of the tool main body on a main spindle of a machine tool.

2. The boring tool according to claim 1, wherein the positioning means is biasing means, interposed between the center hole and the draw bar, for biasing the draw bar in the tool axial direction.

3. The boring tool according to claim 1, wherein the positioning means includes:
an engagement member supported to be capable of advancing to and retreating from the center hole; and
a recess portion formed on an outer peripheral surface of the draw bar and configured to engage with the engagement member.

4. The boring tool according to claim 1, wherein the cutting edge position adjusting means includes:
a cutter supporting member to which the cutter is attached and which elastically deforms outward in the tool radial direction from the outer peripheral portion of the tool main body;
an inclined surface which is formed on the draw bar and which is inclined inward in the tool radial direction; and
a pushing pin which is supported to be slidable in the tool radial direction in the tool main body and which pushes the cutter supporting member outward in the tool radial direction by sliding on the inclined surface.

5. The boring tool according to claim 4, wherein the draw bar is configured such that a front end side shaft portion including the inclined surface is separable.

6. The boring tool according to claim 1, wherein the cutting edge position adjusting means includes:
a guide plate which slides in the tool axial direction together with the draw bar;
a guide groove which is formed in the guide plate and which is inclined with respect to the tool axial direction;
a cutter supporting member to which the cutter is attached and which is supported on the tool main body to be slidable in the tool radial direction; and
a slide pin which has one end slidably supported in the guide groove and another end fixed to the cutter supporting member.

7. The boring tool according to claim 6, wherein the guide plate is detachably attached to the draw bar.

8. The boring tool according to claim 1, wherein a plurality of the cutting edge position adjusting means are provided in the tool axial direction.
